(19) United States
(12) Patent Application Publication
(10) Pub. No.: US 2014/0374483 A1
(43) Pub. Date: Dec. 25, 2014

(54) ENCODED INFORMATION READING TERMINAL INCLUDING HTTP SERVER

(71) Applicant: Chunhua Lu, Suzhou (CN)

(72) Inventor: Chunhua Lu, Suzhou (CN)

(73) Assignee: HONEYWELL INTERNATIONAL INC., Morristown, NJ (US)

(21) Appl. No.: 14/376,472

(22) PCT Filed: Feb. 15, 2012
(86) PCT No.: PCT/CN2012/071156

§ 371 Date: Aug. 4, 2014

(51) Int. Cl. G06K 7/01; G06K 7/08; G06K 7/10; H04L 29/08

(52) U.S. Cl. CPC G06K 7/01; H04L 67/02; H04L 67/10; H04L 67/146; G06K 7/08; G06K 7/10009; G06K 7/10544
USPC 235/462.01; 235/439

(57) ABSTRACT

An encoded information reading (EIR) terminal can comprise a microprocessor, a memory, a communication interface, and an EIR device, all communicatively coupled to a system bus. The EIR device can be provided by a bar code reading device, an RFID reading device, and/or a card reading device. The EIR terminal can be configured to execute an HTTP server software module. The EIR terminal can be further configured, responsive to receiving an HTTP request, to transmit to the originating HTTP client an HTTP response comprising at least one HTML page including one or more input fields configured to receive one or more terminal configuration parameters. The EIR terminal can be further configured, responsive to receiving an HTTP request comprising one or more values of the terminal configuration parameters, to perform at least one terminal configuration operation based on the values of the terminal configuration parameters.

### FIELD OF THE INVENTION

The present invention relates generally to encoded information reading terminals, and in particular to encoded information reading terminals adapted to receive terminal configuration commands.

### BACKGROUND OF THE INVENTION

Encoded information reading (EIR) terminals are widely used in retail stores, shipping facilities, etc. An EIR terminal can have one or more configuration parameters used to control various aspects of the terminal functioning.

### SUMMARY OF THE INVENTION

In one embodiment, there is provided an encoded information reading (EIR) terminal. The EIR terminal can comprise a microprocessor, a memory, a communication interface, and an EIR device, all communicatively coupled to a system bus. The EIR device can be provided by a bar code reading device, an RFID reading device, and/or a card reading device. The EIR terminal can be configured to execute an HTTP server software module. The EIR terminal can be further configured, responsive to receiving an HTTP request, to transmit to the originating HTTP client an HTTP response comprising at least one HTML page comprising at least one HTML element defining one or more input fields configured to receive one or more terminal configuration parameters. The EIR terminal can be further configured, responsive to receiving an HTTP request comprising one or more values of the terminal configuration parameters, to perform at least one terminal configuration operation based on the values of the terminal configuration parameters.

In another embodiment, there is provided an encoded information reading (EIR) terminal. The EIR terminal can comprise a microprocessor, a memory, a communication interface, and an EIR device, all communicatively coupled to a system bus. The EIR device can be provided by a bar code reading device, an RFID reading device, and/or a card reading device. The EIR terminal can be configured to execute an HTTP server software module. The EIR terminal can be further configured, responsive to receiving an HTTP request comprising an SML expression encoding a terminal configuration command, to perform a terminal configuration operation by executing said terminal configuration command.

### BRIEF DESCRIPTION OF THE DRAWINGS

The objects and features of the invention can be better understood with reference to the claims and drawings described below. The drawings are not necessarily to scale, the emphasis is instead generally being placed upon illustrating the principles of the invention. Within the drawings, like reference numbers are used to indicate like parts throughout the various views.

FIG. 1 schematically illustrates a network-level layout of one embodiment of a data collection system utilizing EIR terminals;

FIG. 2 schematically illustrates software component diagram of a data collection system utilizing EIR terminals;

FIG. 3 illustrates an example of a terminal configuration screen;

FIG. 4 illustrates an example of SOAP message containing an EIR terminal configuration command;

FIGS. 5a-5c, 6, and 7 schematically illustrate embodiments of an EIR terminal;

FIG. 8 depicts a component-level layout of an EIR terminal;

### DETAILED DESCRIPTION OF THE INVENTION

In one embodiment, there is provided an encoded information reading (EIR) terminal comprising one or more EIR devices, including a bar code reading device, an RFID reading device, and/or a card reading device. The EIR terminal can be capable of reading bar codes, RFID tags and/or other encoded message carriers.

Encoded messages, for example, UPC bar codes comprising twelve encoded characters representing numerical digits, can be used to convey identification of the source and the model of a product. The EIR terminal can be configured, responsive to reading an encoded message by the EIR device, to produce a decoded message string by decoding the encoded message.

The EIR terminal can comprise a communication interface, which can be provided, e.g., by an Ethernet interface or by IEEE-802.11x-compliant wireless interface. Using the communication interface, one or more software modules being executed by the EIR terminal can communicate with external clients and/or servers.

In one embodiment, the EIR terminal can be configured to execute an HTTP server software module which can be configured, responsive to receiving an HTTP request from an HTTP client, to transmit an HTTP response to the client. In a further aspect, the HTTP server software module can be configured, responsive to receiving a first HTTP request from an HTTP client, to transmit an HTTP response comprising at least one HTML page. The HTML page can include one or more HTML elements defining input fields to be rendered by the requesting client. The input fields can be configured to receive user input comprising one or more terminal configuration parameters. The HTTP server software module can be further configured, responsive to receiving from the HTTP client a second HTTP request comprising one or more values of the terminal configuration parameters, to perform at least one terminal configuration operation based on the specified values of the terminal configuration parameters.

In another embodiment, an HTTP request can include a terminal configuration command. In one embodiment, the terminal configuration command can be encoded by an XML expression. The HTTP server software module can be configured, responsive to receiving a terminal configuration command embedded into an HTTP request, to perform a terminal configuration operation by executing the terminal configuration command. In a further aspect, the configuration command can be, e.g., an imager configuration command, a communication interface configuration command, or a data formatting command.

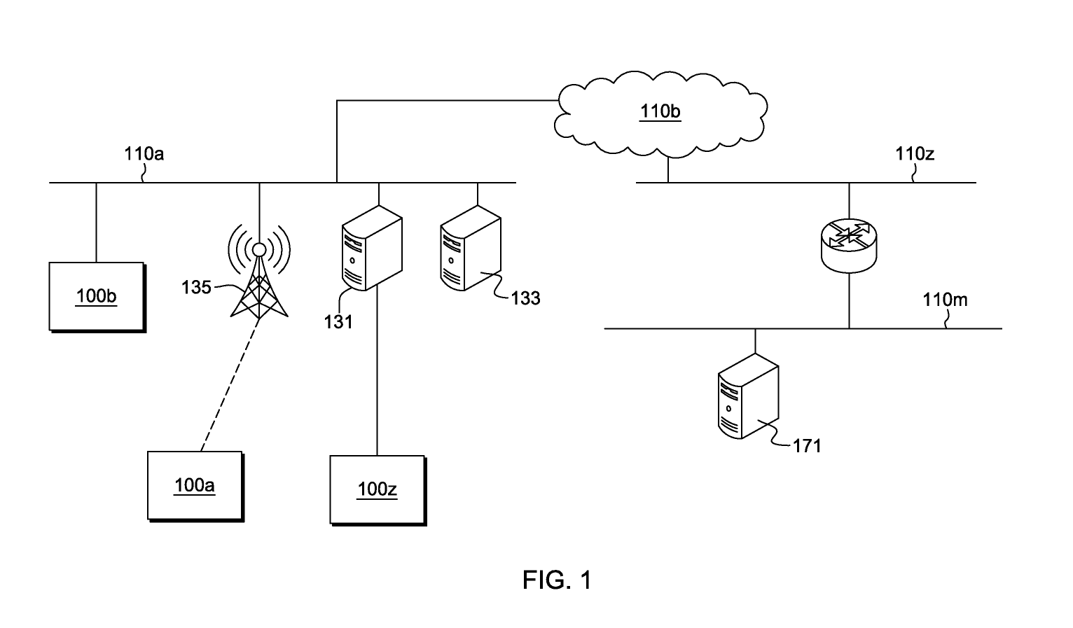

The EIR terminal described herein can be used, for example, for bar code reading and decoding in point-of-sale (POS) and other applications. In one embodiment, EIR terminal 100 can be incorporated into a retail store data collection system 1000 schematically illustrated in FIG. 1, and can be employed at a checkout register for scanning identification tags (e.g., bar code tags) of retail items being purchased by retail customers. Data collection system 1000 can include a plurality of EIR terminals 100a-100z in communication with a plurality of interconnected networks 110a-110z. EIR terminal 100 can connect to one or more networks 110a-110z, e.g., via a wireless access point 135. In one embodiment, at least one of networks 110a-110z can be provided by an IEEE 802.11x-compliant wireless network. In another embodiment, at least one of networks 110a-110z can be provided by an Ethernet network. In another embodiment, at least one of networks 110a-110z can be provided by a local area network (LAN). In another embodiment, at least one of networks 110a-110z can be provided by a wide area network (WAN). While different networks are designated herein, it is recognized that a single network as seen from the network layer of the OSI model can comprise a plurality of lower layer networks, i.e., what can be regarded as a single Internet Protocol (IP) network, can include a plurality of different physical networks.

In one embodiment, EIR terminal 100 can exchange messages with one or more external computers, including, for example, checkout register 131, retail store server 133, and/or remote server 171. A “computer” herein shall refer to a programmable device for data processing, including a central processing unit (CPU), a memory, and at least one communication interface. A computer can be provided, e.g., by a personal computer (PC) running Windows™ operating system. A skilled artisan would appreciate the fact that other hardware platforms and operating systems are within the spirit and the scope of the invention.

In a further aspect, EIR terminal 100 can be communicatively coupled via wired or wireless interface to checkout register 131. EIR terminal 100 can further be in communication with retail store server 133 via wireless access point 135 and network 110a. EIR terminal 100 can further be in communication with remote server 171 via wireless access point 135 and networks 110a, 110b, 110z. A skilled artisan would appreciate the fact that other methods of EIR terminal communicatively coupling to checkout register 131, store server 133, and remote server 171 are within the scope of this disclosure.

At least one of the messages transmitted by EIR terminal 100 to one or more external computers 131, 133, and/or 171 can include decoded message data corresponding to, e.g., a bar code label or an RFID label attached to a retail item. For example, EIR terminal 100 can transmit to the checkout register 131 a product identifier encoded by a bar code label attached to the product. In another example, EIR terminal 100 can transmit a request to retail store server 133 to retrieve product information corresponding to a product identifier encoded by a bar code label attached to the product.

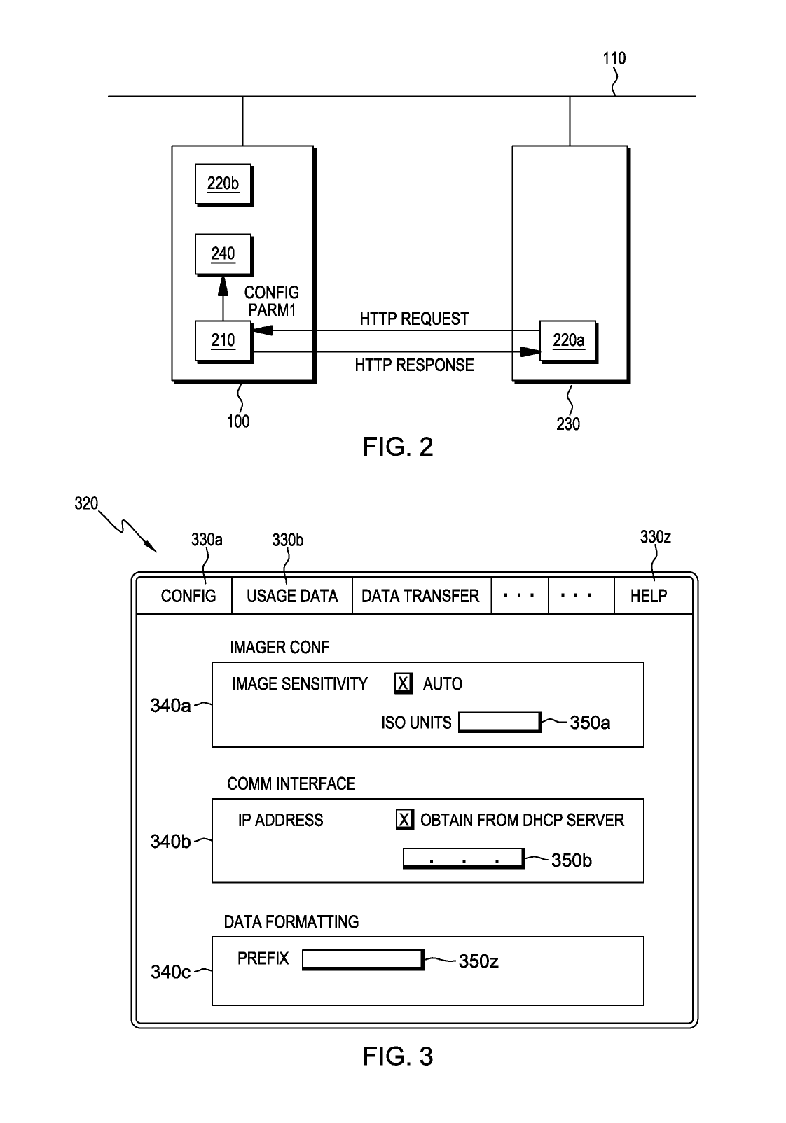

As noted herein supra, EIR terminal 100 can be configured to execute an HTTP server software module 210, as best viewed in FIG. 2. HTTP server software module 210 can be in communication with HTTP client 220. In one embodiment, HTTP client 220 can be provided by an external HTTP client, e.g., HTTP browser 220a being executed by an external computer 230. External computer 230 can be in communication with EIR terminal 100 via one or more networks 110a-110z.

In one embodiment, HTTP server software module 210 can be provided by Apache software module. In another embodiment, HTTP server software module 210 can be provided by Internet Information Server software module by Microsoft Corp. In a yet another embodiment, HTTP server software module can be provided by a custom software module compliant with HTTP/1.1 protocol defined by RFC-2616 by the Internet Society (1999).

In a further aspect, HTTP server software module 210 can be configured to receive and process HTTP requests from one or more HTTP clients. An HTTP request can include a request line, one or more headers (e.g., a request header) and a request body.

A request line is a character string that can include an identifier of a resource and an identifier of a method (method token) to be applied to the resource. The method token can be provided by one of the following tokens: OPTIONS, GET, HEAD, POST, PUT, DELETE, TRACE, CONNECT. In one embodiment, HTTP server software module 210 can only support GET and HEAD methods, replying with 501 error code (“Method not implemented”) if the requested method is not recognized or not implemented. The identifier of the resource can be provided by a Uniform Resource Identifier (URI) and can identify the resource upon which to apply the request.

One example of an HTTP request line would be:

GET /pub/WWW/TheProject.html HTTP/1.1

In a further aspect, a request header is a character string comprising one or more request header fields that can be employed by an HTTP client to pass additional information about the request, and/or and about the client itself, to the HTTP server. For example, the User-agent request header field can contain information about the HTTP client (user agent) originating the HTTP request. The information can be used by the HTTP server for statistical purposes, tracing of protocol violations, and automated recognition of user agents for tailoring responses to avoid particular user agent limitations.

After receiving and interpreting an HTTP request message, HTTP server software module 210 can respond with an HTTP response message. An HTTP response can include a status line, one or more headers (e.g., a response header) and a response body.

A status line can is a character string which can include a numeric status code and its associated textual phrase. The status code can be provided by a 3-digit integer result code of the attempt to satisfy the HTTP request. The associated textual phrase is intended to give a human user a short textual description of the status code. Examples of status codes and associated textual phrases include:
200—OK
301—Moved Permanently
307—Temporary Redirect
400—Bad Request
401—Unauthorized
403—Forbidden
404—Not Found

In a further aspect, a response header is a character string comprising one or more response header fields that can be employed by an HTTP server to pass additional information about further access to the resource identified by the Request-URI and/or about the HTTP server to the HTTP client.

In a further aspect, the response body can contain Hyper-Text Markup Language (HTML) code intended to be interpreted by the HTTP client that transmitted the HTTP request. In one embodiment, the HTTP client can be provided by browser 220a executed by external computer 230 of FIG. 2. Browser 220a can render on the screen of computer 230 one or more pages defined by the HTML code returned within the HTTP response body.

In one embodiment, HTTP server 210 can be configured, responsive to receiving a first HTTP request from an HTTP client, to transmit an HTTP response comprising at least one HTML page. The HTML page can include one or more input fields configured to receive one or more terminal configuration parameters. In one embodiment, the HTML page can include at least one HTML <form> tag and one or more input elements. The HTTP client provided, e.g., by browser 220a, can render on the screen of computer 230 one or more pages defined by the HTML code returned within the HTTP response body.

In one embodiment, the HTTP response transmitted by the HTTP server 210 can comprise at least one static HTML page. A static HTML page can be stored as an HTML file in the file system accessible by the HTTP server 210, and can be retrieved by the HTTP server 210 responsive to receiving an HTTP request referencing the HTML page. Static HTML pages can be advantageously used, e.g., to deliver to a client an input form or an informational page containing no variable information.

FIG. 3 illustrates an example of a terminal configuration screen rendered by browser 220a on the screen of computer 230. The terminal configuration page 310 can comprise a tab control 320 including two or more tabs 330a-330z, e.g., Configuration tab 330a. The Configuration page, selectable by tab 330a can comprise one or more panels, e.g., Imager Configuration panel 340a, Communication Interface Configuration panel 340b, and Data formatting panel 340c. Each of the panels 340a-340c can comprise one or more input fields 350a-350z.

In another embodiment, the HTML page returned within the HTTP response body can by dynamically generated by the EIR terminal 100 responsive to receiving an HTTP request. In a further aspect, HTTP server 210 can generate a dynamic HTML page using Java Script, Java Server Pages, servlets, and/or other server-side technologies. Dynamic HTML pages can be advantageously used, e.g., to deliver to a client variable information, such as, for example, values of one or more terminal configuration parameters.

In a further aspect, the HTTP response returned by the EIR terminal 100 can comprise one or more HTTP cache-control directives. For the purposes of this disclosure, cache can be defined as a storage and/or a method of storing HTTP response messages by a user agent (HTTP client) or by an HTTP proxy server. The effect of a cache is that the request/response chain is shortened if one of the participants along the chain has a cached response applicable to that request. A response is cacheable if a cache is allowed to store a copy of the response message for use in answering subsequent requests. For example, a static HTML page containing no variable information can be cacheable. In another example, a dynamic HTML page containing values of one or more EIR terminal configuration parameters should not be cacheable, since the parameter values can change in time. In one embodiment, cacheability of an HTTP response can be controlled by the HTTP server 210 inserting one or more HTTP cache-control directives into the HTTP response.

To indicate that an HTTP response is cacheable, HTTP server 210 can insert into the HTTP response a cache-control directive comprising a response expiration time in the future. For the purposes of this disclosure, an expiration time can be defined as the time at which the origin HTTP server intends that a previously cached HTTP response should be discarded or revalidated.

A no-cache directive can be used by HTTP server 210 to indicate to an HTTP client or HTTP proxy server that a cache must not use an HTTP response to satisfy a subsequent request without successful revalidation with the origin HTTP server. Another method for HTTP server 210 to force an HTTP client or a proxy server to validate every request is to assign to an HTTP response an expiration time in the past. A yet another method for HTTP server 210 to force any HTTP client or HTTP proxy server, no matter how it is configured, to validate every HTTP request, is to use must-revalidate cache-control directive.

In a further aspect, HTTP server can insert private cache control directive into an HTTP response to indicate that all or part of the HTTP response is intended for a single user and must not be cached by a shared cache (e.g., by an HTTP proxy server).

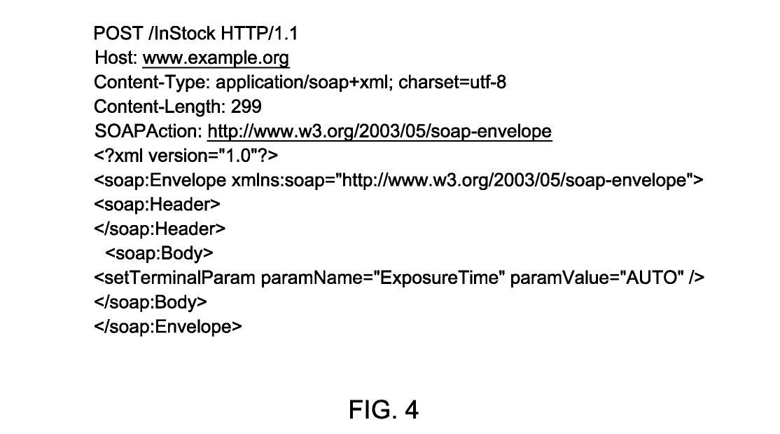

Responsive to receiving an HTML page, computer 230 can render the page on its screen. An operator of computer 230 can fill in one or more parameter values into the input fields presented on the screen of computer 230 and then click the Submit button. Responsive to detecting the Submit button click event, browser 220a can transmit to HTTP server 210 an HTTP request comprising one or more values of the terminal configuration parameters. In one embodiment, the HTTP request can include form data for the form defined by the HTML <form> tag and input elements contained in the HTML page previously transmitted to the HTTP client by the HTTP server. In one embodiment, the HTTP request can include one or more SOAP messages. SOAP is a protocol specification for exchanging structured information in the implementation of web services in computer networks. A SOAP-compliant message can be embedded in an XML envelope and can be transmitted over HTTP or Simple Mail Transfer Protocol (SMTP). An example of SOAP message containing terminal configuration parameter values command is depicted in FIG. 4.

HTTP server 210 can be further configured, responsive to receiving from browser 220a an HTTP request comprising one or more values of the terminal configuration parameters, to invoke terminal configuration software module 240 and pass to it the terminal configuration parameters.

In another aspect, HTTP server 210 can be configured to request an authentication of the HTTP client attempting to access one more resources identified by one or more URIs. In one embodiment, the list of URIs requiring client identification can be included into the configuration file of the HTTP server 210. In one embodiment, a session can be established responsive to the HTTP server 210 validating a user's credentials, and all subsequent HTTP requests from the same HTTP client will be treated as originated by the authenticated user, unless the HTTP client sends a log-out command or the session otherwise terminates (e.g., by the user closing the browser or by the HTTP server 210 ending the session due to the HTTP client's inactivity).

In one embodiment, HTTP server 210 can use HTTP cookies for session support. Using a Set-Cookie header of an HTTP response, HTTP server 210 can send to HTTP client 220 an alphanumeric string that HTTP client 220 will return in future HTTP requests addressed to URIs identified by the cookie's Path and Domain directives. For example, HTTP server 210 can send to HTTP client 220 a session identifier named SessionID with the value 543210. HTTP client 220 can then return the session identifier in subsequent HTTP requests. In another embodiment, HTTP server 210 can use dynamic Uniform Resource Locators (URLs) for session support. In a yet another embodiment, HTTP server 210 can use HTTP forms with hidden fields for session support. In a yet another embodiment, HTTP server 210 can use any combinations of cookies, dynamic URLs, and HTTP forms with hidden fields for session support.

As noted herein supra, in one embodiment, HTTP client 220 can be provided by browser 220a executed by external computer 230 of FIG. 2. In another embodiment, HTTP client 220 can be provided by browser 220b executed locally by EIR terminal 100. Thus, the operator of the EIR terminal can issue terminal configuration commands using the terminal's keyboard 3134. In a yet another embodiment, HTTP client 220 can be provided by a custom HTTP client 220c which is configured to communicate to HTTP server 210 via HTTP protocol while having limited or none HTML browser functionality. In one embodiment, custom HTTP client 220c can be executed by external computer 230c which can be in communication with EIR terminal 100 via one or more networks 110a-110z. In another embodiment, custom HTTP client 220c executed locally by EIR terminal 100.

In a further aspect, custom HTTP client 220c can transmit to HTTP server 210 an HTTP request that can include a terminal configuration command. In one embodiment, the terminal configuration command can be embedded into the body of the HTTP request. In another aspect, the terminal configuration command can be embedded into a fictitious URI identifying the resource to be used, e.g., by GET method. In another embodiment, other method tokens can be used, e.g., POST or PUT.

EIR terminal 100 can be configured, responsive to receiving a terminal configuration command embedded into an HTTP request, to perform a terminal configuration operation by executing the terminal configuration command. In a further aspect, HTTP server 210 can parse an incoming HTTP request, and responsive to detecting a terminal configuration command, can invoke terminal configuration software module 240 and pass to it the terminal configuration command.

In one embodiment, the terminal configuration command can include a terminal parameter name and a parameter value. Terminal configuration software module 240 can be configured, responsive to receiving the terminal configuration command, to assign the parameter value to the terminal parameter identified by the parameter name.

In one embodiment, the terminal configuration command can include a terminal parameter name and a parameter toggle command. Terminal configuration software module 240 can be configured, responsive to receiving the terminal configuration command, to toggle the value of the terminal parameter identified by the parameter name, e.g., by applying the exclusive OR logical operation to the current parameter binary value, using logical “1” as the second operand.

In one embodiment, the terminal configuration command can include a name of an executable module to be executed by the terminal. The terminal configuration command can further include one or more parameters to be passed to the executable module.

In one embodiment, the terminal configuration command can be encoded using SOAP protocol. An example of SOAP message containing an EIR terminal configuration command is depicted in FIG. 4.

In another aspect, a terminal configuration command transmitted by HTTP client 220 to HTTP server 210 can be, e.g., an imager configuration command, a communication interface configuration command, or a data formatting command.

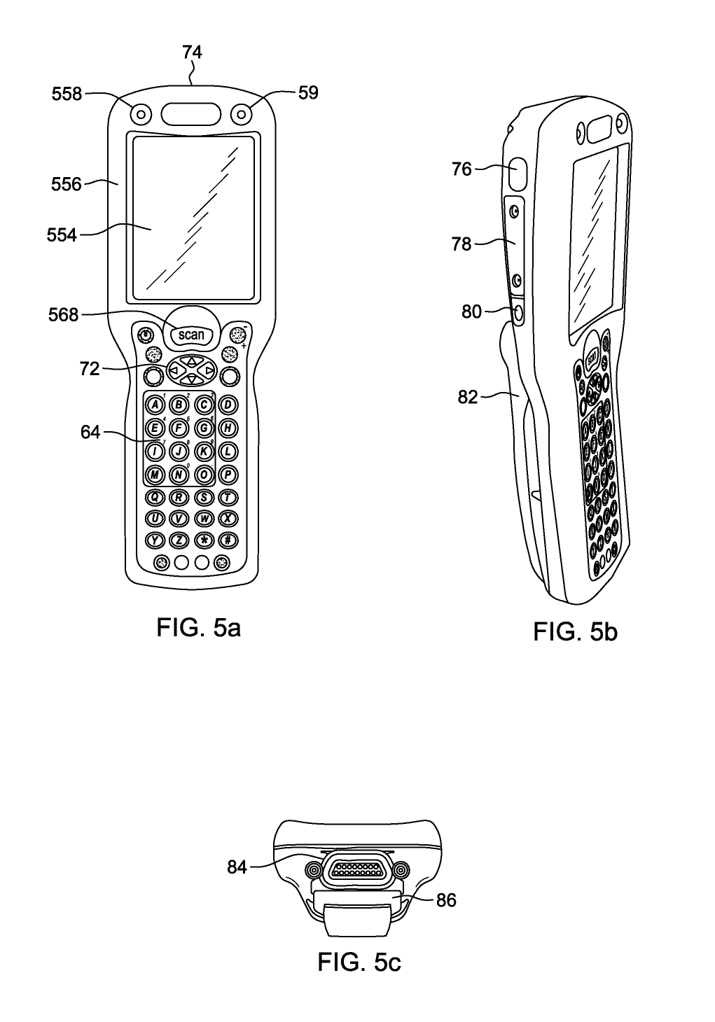

One embodiment of EIR terminal 100 is shown in FIGS. 5a (front panel view), 5b (side panel view), and 5c (bottom panel view). EIR terminal 100 can comprise housing 52 within which other components of EIR terminal 100 can be disposed. LCD screen display with touch screen sensor 554 can be disposed on the front panel 556. Also disposed on front panel 556 can be decode LED 558, scan led 59, and keyboard 64 including scan key 568 and navigation keys 72. Imaging window 74 can be disposed on the top panel of housing 52. Disposed on the side panel (best viewed in FIG. 5b) can be infra-red communication port 76, access door to a secure digital (SD) memory interface 78, audio jack 80, and hand strap 82. Disposed on the bottom panel (best viewed in FIG. 5c) can be multi-pin mechanical connector 84 and hand strap clip 86.

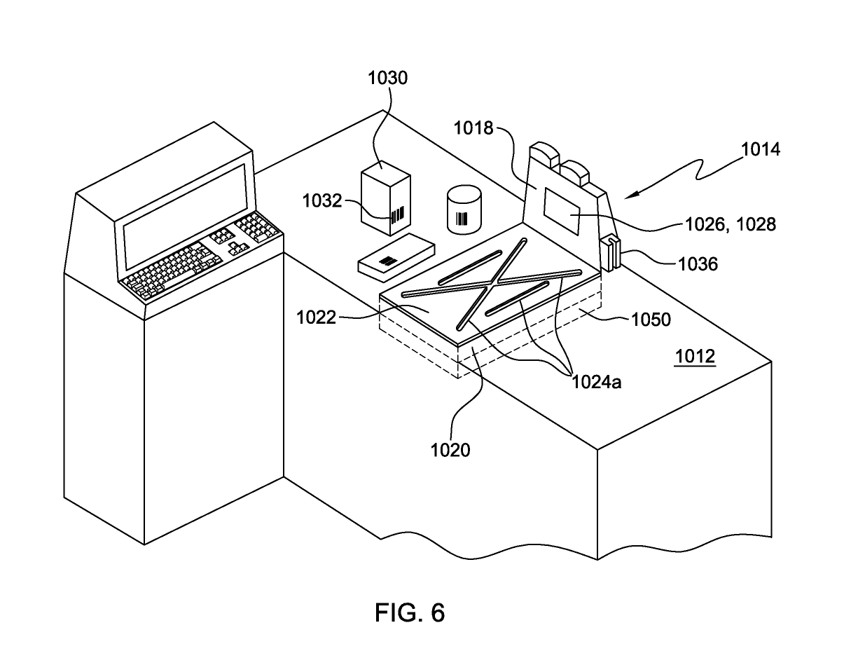

While FIGS. 5a-5c illustrate a hand held housing, a skilled artisan would appreciate the fact that other types and form factors of terminal housings are within the scope of this disclosure. For example, in one embodiment schematically shown in FIG. 6, an EIR terminal can be incorporated into a POS workstation with a presentation housing. The workstation 1010 can include a horizontal countertop 1012 for placement of products to be scanned A bioptic scanner 1014 mounted within the countertop 1012 can include a first housing portion 1016 and a second housing portion 1018 which can project from one end of the first housing portion in a substantially orthogonal manner In one embodiment, the first housing portion 1016 can comprise a laser-based indicia scanning terminal and the second housing portion 1018 can comprise an imager-based terminal. The countertop 1012 can include an optically transparent (e.g., glass) horizontal-scanning window 1020 mounted flush with the checkout counter, covered by an imaging window protection plate 1022 which can be provided with a pattern of apertures 1024a. The second housing portion 1018 can further include a vertical-scanning window 1026 behind which an imager-based indicia reading terminal 1028 can be housed. A skilled artisan would appreciate the fact that other ways of disposing the scanners and scanning windows are within the scope of this disclosure.

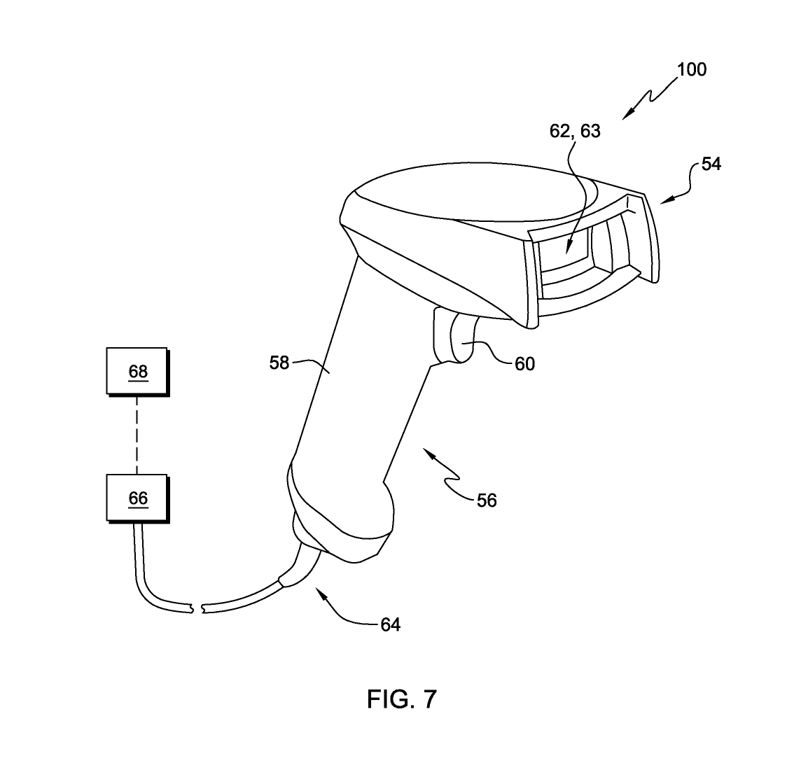

In another illustrative embodiment, shown in FIG. 7, there is provided an EIR terminal 100 including a housing 52 comprising a head portion 54 and a handle portion 56, the latter further comprising a hand grip 58 and a trigger 60. The trigger 60 can be used to initiate signals for activating frame readout and/or certain decoding processes. Other components of EIR terminal 100 can be disposed within the housing 52. For example, an image sensor 62 can be disposed in the head portion 54 behind a housing window 63. The image sensor 62 can be configured to output an electrical signal representative of light incident on the image sensor. EIR terminal 100 can further comprise an I/O interface which in the illustrative embodiment of FIG. 7 can be communicatively coupled to a wired connection 66. The I/O interface can be used to communicatively couple EIR terminal 100 to a companion device 68 such as a register and/or peripheral data capture devices in a POS application. Other configurations of the I/O interface may utilize wireless communication technology and/or contact-type features that do not require wires and/or wired connection 66. In certain applications of EIR terminal 100 for example, the companion device 68 may be provided by a docking station with corresponding mating contacts and/or connectors that are useful to exchange power and data, including image data captured by the image sensor 62. Although not incorporated in the illustrative embodiment of FIG. 7, EIR terminal 100 can also comprise a number of peripheral devices, including a display for displaying such information as image frames captured by the terminal, a keyboard, and a pointing device.

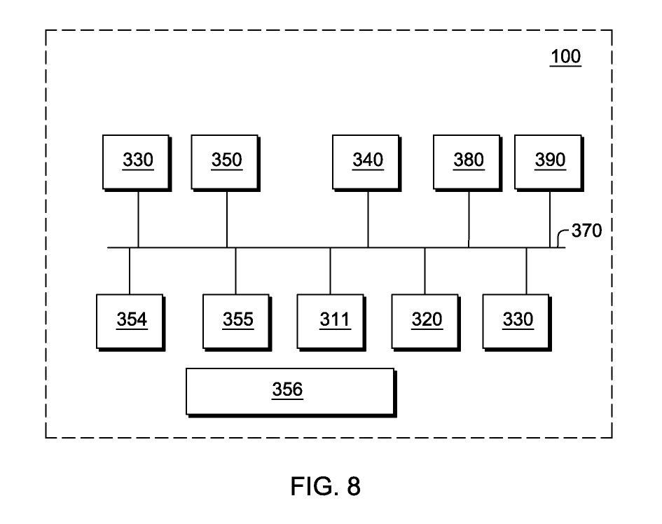

Component-level diagram of one embodiment of an EIR terminal is now being described with references to FIG. 8. EIR terminal 100 can comprise at least one microprocessor 311 and a memory 321, both coupled to the system bus 370. The microprocessor 311 can be provided by a general purpose microprocessor or by a specialized microprocessor (e.g., an ASIC). In one embodiment, EIR terminal 100 can comprise a single microprocessor which can be referred to as a central processing unit (CPU). In another embodiment, EIR terminal 100 can comprise two or more microprocessors, for example, a CPU providing some or most of the EIR terminal functionality and a specialized microprocessor performing some specific functionality. A skilled artisan would appreciate the fact that other schemes of processing tasks distribution among two or more microprocessors are within the scope of this disclosure.

EIR terminal 100 can further comprise a communication interface 340 communicatively coupled to the system bus 370. In one embodiment, the communication interface can be provided by a wireless communication interface. The wireless communication interface can be configured to support, for example, but not limited to, the following protocols: at least one protocol of the IEEE 802.11/802.15/802.16 protocol family, at least one protocol of the HSPA/GSM/GPRS/EDGE protocol family, TDMA protocol, UMTS protocol, LTE protocol, and/or at least one protocol of the CDMA/1xEV-DO protocol family.

EIR terminal 100 can further comprise a keyboard interface 354 and a display adapter 355, both also coupled to the system bus 370. EIR terminal 100 can further comprise a battery 356. In one embodiment, the battery 356 can be provided by a replaceable rechargeable battery pack.

EIR terminal 100 can further comprise a GPS receiver 380. EIR terminal 100 can further comprise at least one connector 390 configured to receive a subscriber identity module (SIM) card.

EIR terminal 100 can further comprise one or more EIR devices 330, provided, for example, but not limited to, by an RFID reading device, a bar code reading device, or a card reading device. In one embodiment, the RFID terminal can be configured to read an encoded message using EIR device 330, and to output raw message data containing the encoded message. In another embodiment, the RFID terminal can be configured to read an encoded message using EIR device 330, and to output decoded message data corresponding to the encoded message. As used herein, “message” is intended to denote a character string comprising alphanumeric and/or non-alphanumeric characters. An encoded message can be used to convey information, such as identification of the source and the model of a product, for example, in a UPC code.

Of course, devices that read bar codes, read RFID, or read cards bearing encoded information may read more than one of these categories while remaining within the scope of this disclosure. For example, a device that reads bar codes may include a card reader, and/or RFID reader; a device that reads RFID may also be able to read bar codes and/or cards; and a device that reads cards may be able to also read bar codes and/or RFID. For further clarity, it is not necessary that a device's primary function involve any of these functions in order to be considered such a device; for example, a cellular telephone, smartphone, or PDA that is capable of reading bar codes is a device that read bar codes for purposes of this disclosure.

While the present invention has been particularly shown and described with references to certain exemplary embodiments, it will be understood by one skilled in the art that various changes in detail may be affected therein without departing from the spirit and scope of the invention as defined by claims that can be supported by the written description and drawings. Further, where exemplary embodiments are described with reference to a certain number of elements it will be understood that the exemplary embodiments can be practiced utilizing less than the certain number of elements.

A small sample of systems methods and apparatus that are described herein is as follows:

A1. An encoded information reading (EIR) terminal comprising:

a microprocessor communicatively coupled to a system bus;

a memory communicatively coupled to said system bus;

a communication interface coupled to said system bus;

an EIR device communicatively coupled to said system bus, the EIR device selected from the group consisting of: a bar code reading device, an RFID reading device, and a card reading device;

a microprocessor communicatively coupled to said system bus;

wherein said EIR terminal is configured is configured to execute an HTTP server software module;

wherein said EIR terminal is further configured, responsive to receiving a first HTTP request from an HTTP client, to transmit an HTTP response to said HTTP client, said HTTP response comprising at least one HTML page, said at least one HTML page including at least one HTML element defining one or more input fields configured to receive one or more terminal configuration parameters;

wherein said EIR terminal is further configured, responsive to receiving from said HTTP client a second HTTP request comprising one or more values of said one or more terminal configuration parameters, to perform at least one terminal configuration operation based on said one or more values of said one or more terminal configuration parameters.

A2. The EIR terminal of A1, wherein said at least one HTML page is provided by a dynamically generated HTML page.

A3. The EIR terminal of A1, wherein said at least one HTML page is provided by a static HTML page; and wherein said HTTP response comprises an element defining said HTTP response as being cacheable.

A4. The EIR terminal of A1, wherein said HTTP response comprises an element defining said HTTP response as being non-cacheable.

A5. The EIR terminal of A1, wherein said first HTTP request comprises a reference to at least one terminal configuration parameter.

A6. The EIR terminal of A1, wherein said first HTTP request and said second HTTP requests are transmitted by one of: a local HTTP client, an external HTTP client.

A7. The EIR terminal of A1, wherein at least one input field of said one or more input fields is configured to accept a character string parameter value.

A8. The EIR terminal of A1, wherein at least one input field of said one or more input fields is configured to accept a numeric parameter value.

A9. The EIR terminal of A1, wherein at least one input field of said one or more input fields is configured to accept a binary parameter value.

A10. The EIR terminal of A1, wherein at least one input field of said one or more input fields is configured to accept an executable module name and at least one executable module parameter.

A11. The EIR terminal of A1, wherein at least one terminal configuration parameter of said one or more terminal configuration parameters is provided by one of: an imager configuration parameter, a communication interface configuration parameter, a data formatting parameter.

A12. The EIR terminal of A1, wherein said HTTP server software module is configured to request authentication of said HTTP client.

A13. The EIR terminal of A1, wherein said HTTP server software module is configured to communicate over HTTPS protocol.

A14. The EIR terminal of A1, wherein said EIR terminal is further configured to embed a result of said terminal configuration operation into a second HTTP response transmitted to said HTTP client responsive to completing at least one terminal configuration operation.

B1. An encoded information reading (EIR) terminal comprising:

a microprocessor communicatively coupled to a system bus;

a memory communicatively coupled to said system bus;

a communication interface coupled to said system bus;

an EIR device communicatively coupled to said system bus, the EIR device selected from the group consisting of: a bar code reading device, an RFID reading device, and a card reading device;

a microprocessor communicatively coupled to said system bus;

wherein said microprocessor is configured to execute an HTTP server software module;

wherein said EIR terminal is configured, responsive to receiving from an HTTP client an HTTP request comprising an XML expression encoding a terminal configuration command, to perform a terminal configuration operation by executing said terminal configuration command.

B2. The EIR terminal of B1, wherein said HTTP request is transmitted by one of: a local HTTP client, an external HTTP client.

B3. The EIR terminal of B1, wherein said terminal configuration command includes a parameter name and a parameter value.

B4. The EIR terminal of B1, wherein said terminal configuration command includes a parameter name and a parameter toggle command.

B5. The EIR terminal of B1, wherein said terminal configuration command includes an executable module name and at least one executable module parameter.

B6. The EIR terminal of B1, wherein said terminal configuration command is provided by one of: an imager configuration command, a communication interface configuration command, a data formatting command.

B7. The EIR terminal of B1, wherein said HTTP server software module is configured to request authentication of said HTTP client.

B8. The EIR terminal of B1, wherein said HTTP server software module is configured to request authentication of said HTTP client responsive to ascertaining that said HTTP client is provided by an external HTTP client.

B9. The EIR terminal of B1, wherein said HTTP server software module is configured to communicate over HTTPS protocol.

B10. The EIR terminal of B1, wherein said EIR terminal is further configured to embed a result of said terminal configuration operation into an HTTP response transmitted to said HTTP client.

1. An encoded information reading (EIR) terminal comprising:
a microprocessor communicatively coupled to a system bus;
a memory communicatively coupled to said system bus;
a communication interface coupled to said system bus;
an EIR device communicatively coupled to said system bus, the EIR device selected from the group consisting of: a bar code reading device, an RFID reading device, and a card reading device;
a microprocessor communicatively coupled to said system bus;
wherein said EIR terminal is configured is configured to execute an HTTP server software module;
wherein said EIR terminal is further configured, responsive to receiving a first HTTP request from an HTTP client, to transmit an HTTP response to said HTTP client, said HTTP response comprising at least one HTML page, said at least one HTML page including at least one HTML element defining one or more input fields configured to receive one or more terminal configuration parameters;
wherein said EIR terminal is further configured, responsive to receiving from said HTTP client a second HTTP request comprising one or more values of said one or more terminal configuration parameters, to perform at least one terminal configuration operation based on said one or more values of said one or more terminal configuration parameters.

2. The EIR terminal of claim 1, wherein said at least one HTML page is provided by a dynamically generated HTML page.

3. The EIR terminal of claim 1, wherein said at least one HTML page is provided by a static HTML page; and
wherein said HTTP response comprises an element defining said HTTP response as being cacheable.

4. The EIR terminal of claim 1, wherein said HTTP response comprises an element defining said HTTP response as being non-cacheable.

5. The EIR terminal of claim 1, wherein said first HTTP request comprises a reference to at least one terminal configuration parameter.

6. The EIR terminal of claim 1, wherein said first HTTP request and said second HTTP requests are transmitted by one of: a local HTTP client, an external HTTP client.

7. The EIR terminal of claim 1, wherein at least one input field of said one or more input fields is configured to accept a character string parameter value.

8. The EIR terminal of claim 1, wherein at least one input field of said one or more input fields is configured to accept a numeric parameter value.

9. The EIR terminal of claim 1, wherein at least one input field of said one or more input fields is configured to accept a binary parameter value.

10. The EIR terminal of claim 1, wherein at least one input field of said one or more input fields is configured to accept an executable module name and at least one executable module parameter.

11. The EIR terminal of claim 1, wherein at least one terminal configuration parameter of said one or more terminal configuration parameters is provided by one of: an imager configuration parameter, a communication interface configuration parameter, a data formatting parameter.

12. The EIR terminal of claim 1, wherein said HTTP server software module is configured to request authentication of said HTTP client.

13. The EIR terminal of claim 1, wherein said HTTP server software module is configured to communicate over HTTPS protocol.

14. The EIR terminal of claim 1, wherein said EIR terminal is further configured to embed a result of said terminal configuration operation into a second HTTP response transmitted to said HTTP client responsive to completing at least one terminal configuration operation.

15. An encoded information reading (EIR) terminal comprising:
a microprocessor communicatively coupled to a system bus;
a memory communicatively coupled to said system bus;
a communication interface coupled to said system bus;
an EIR device communicatively coupled to said system bus, the EIR device selected from the group consisting of: a bar code reading device, an RFID reading device, and a card reading device;
a microprocessor communicatively coupled to said system bus;
wherein said microprocessor is configured to execute an HTTP server software module;
wherein said EIR terminal is configured, responsive to receiving from an HTTP client an HTTP request comprising an XML expression encoding a terminal configuration command, to perform a terminal configuration operation by executing said terminal configuration command.

16. The EIR terminal of claim 15, wherein said HTTP request is transmitted by one of: a local HTTP client, an external HTTP client.

17. The EIR terminal of claim 15, wherein said terminal configuration command includes a parameter name and a parameter value.

18. The EIR terminal of claim 15, wherein said terminal configuration command includes a parameter name and a parameter toggle command.

19. The EIR terminal of claim 15, wherein said terminal configuration command includes an executable module name and at least one executable module parameter.

20. The EIR terminal of claim 15, wherein said terminal configuration command is provided by one of: an imager configuration command, a communication interface configuration command, a data formatting command.

21. The EIR terminal of claim 15, wherein said HTTP server software module is configured to request authentication of said HTTP client.

22. The EIR terminal of claim 15, wherein said HTTP server software module is configured to request authentication of said HTTP client responsive to ascertaining that said HTTP client is provided by an external HTTP client.

23. The EIR terminal of claim 15, wherein said HTTP server software module is configured to communicate over HTTPS protocol.

24. The EIR terminal of claim 15, wherein said EIR terminal is further configured to embed a result of said terminal configuration operation into an HTTP response transmitted to said HTTP client.
